(19) United States
(12) Patent Application Publication
(10) Pub. No.: US 2009/0228398 A1
(43) Pub. Date: Sep. 10, 2009

(54) MAXIMUM RUNNING SPREAD

(76) Inventors: David Klein, Oakland, CA (US); Arthur Rosenzweig, Tarrytown, NY (US); Timothy Backshall, Danville, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/042,049

(22) Filed: Mar. 4, 2008

(51) Int. Cl. G06Q 40/00

(52) U.S. Cl. 705/36 R

(57) ABSTRACT

A method of determining index component spreads, includes determining an index DV01 according to index component DV01, determining an implied credit default swap (CDS) notional according to a contract value of a basis point, setting a standard recovery rate as a predetermined constant value, determining a maximum running spread according to the standard recovery rate, implied CDS notional, and the contract value of the basis point, and replacing any index component spread that exceeds the maximum running spread by the maximum running spread for determining the index value.

### FIELD OF THE INVENTION

The present invention relates generally to a method and system of trading and a market indicator. More particularly, the present invention relates to a system and method of trading and a market indicator for providing a cap for purposes related to individual securities, index and reporting.

### BACKGROUND OF THE INVENTION

Exchanges, such as stock exchanges and commodity exchanges, are located all over the world and allow investors to openly and easily access their services. The open access allows for a greater freedom of choice of services. A commodity exchange is an organized market for the purchase and sale of enforceable contracts to deliver a commodity such as silver, corn, iron, or a financial instrument such as treasury bills or a national currency at some future date. Commodity exchanges are also called futures market or futures exchanges. The contracts that are used in the commodity exchanges are also known as futures and are exchanged through a competitive auction process that is normally open to the public at the exchange. The financial instruments such as options and indexes are also traded on commodity exchanges. There is no actual delivery of the commodity, but there is a point at future time where the obligations are cancelled. The parties involved in the exchange delegate the risk involved in a change in price of the commodity. Therefore, such an exchange provides an insurance with risks involved in price fluctuations and it provides a basis for the price the commodities are actually traded.

One type of market that has been gaining popularity over the years is the over-the-counter (OTC) market. The OTC market trades in stocks and bonds that are not on stock exchanges like exchange traded derivatives. The OTC market trades are contracts that are traded between at least two private parties, without going through an intermediary. Such markets have increased in popularity because in part the requirements for listing stocks on the exchanges are very strict.

Credit derivatives are a popular form of trade. A credit derivative is a financial instrument that has its value derived from the creditworthiness of the obligations of a third party, which is isolated and traded. Credit default products including credit default swaps (CDS) are one type of traded credit derivative product.

The credit default swap contracts are basically contracts under which two parties agree to isolate and separately trade the credit risk of a third-party reference entity. Under a credit default swap contract, a protection buyer pays a periodic fee to a protection seller in exchange for a contingent payment by the seller upon a credit event, like a default, happening in the reference entity. When a credit event is triggered, the protection seller then can either take delivery of the defaulted bond or pay the protection buyer.

The mechanics of the over-the counter market are cumbersome and complex and there is a need to simplify. Reliance on external factors adds further variables that have to be taken into account or circumvented. The International Swaps and Derivatives Association (ISDA) has formulated what is called an ISDA credit event and ISDA credit event process. There are, for example, the following credit events that are defined under ISDA: Bankruptcy; Obligation Acceleration; Obligation Default; Failure to Pay; Repudiation/Moratorium; and Restructuring. The ISDA credit event definitions are also a part of the credit derivatives definitions, and therefore, important in the credit derivative world.

There is a need to not be reliant on the ISDA credit event process and also recovery rate determination as such reliance is problematic and cumbersome in practice for both customers and managers. An index is needed that does not rely on bilateral declarations of credit events and therefore, not be so reliant on the credit events themselves.

Further, there are problems in the over-the-counter credit derivatives markets. Risk has been concentrated with dealers instead of being spread across multiple parties via an exchange. The risk upon the participants can be quite high. The market participants have the concern of properly managing the market risk and counterparty credit risk. The risk can be spread to a market intermediary. However, the complexity of the intermediation process still concentrates certain risks upon the dealers that are difficult to hedge. Additionally, dealers cannot trade default swaps on themselves.

### SUMMARY OF THE INVENTION

The foregoing needs are met, to a great extent, by the present invention, wherein in one aspect an apparatus is provided that in some embodiments a method of an index that does not rely on bilateral declarations of credit events and is simple to apply.

In accordance with one embodiment a method of determining index component spreads, including determining an index DV01 according to index component DV01, determining an implied credit default swap (CDS) notional according to a contract value of a basis point, setting a standard recovery rate as a predetermined constant value, determining a maximum running spread according to the standard recovery rate, implied CDS notional, and the contract value of the basis point, replacing any index component spread that exceeds the maximum running spread by the maximum running spread for determining the index value.

Additionally, the maximum running spread can be determined by a product of the implied CDS notional with a value of one being subtracted by the standard recovery rate. The maximum running spread can further include the dividing of, the product of the implied CDS notional with the value of one subtracted by the standard recovery rate, with the contract value of the basis point. The standard recovery rate can be a constant value according to certain preset conditions. There can be the assigning of index components with a certain predetermined weight. There can also be a determining of the index component spread according to whether they trade running or trade upfront. There can also be using of the maximum running spread in determination of the index value for the index components that have ceased trading. There can also be determining the index according to the maximum running spread. Additionally, there can be determining a settlement value from the difference between the index value at a settlement date and the contract index value, and multiplying by the DV01. The implied notional of a contract can be determined at the time the index is constructed based on the individual DV01's of the index members.

In another aspect of the present invention, there can be a set of computer executable instructions for determining index component spreads, stored in a computer readable media, including setting an index DV01, determining an implied credit default swap (CDS) notional according to a contract value of a basis point and the DV01, determining a maximum running spread according to the implied CDS notional, and the DV01, replacing any index component spread that exceeds the maximum running spread by the maximum running spread for determining the index value.

In another aspect of the present invention, there can be a system of determining index component spreads, including a means for determining a preset number of components in the index, a means for setting an index DV01 for the components in the index, a means for determining an implied credit default swap (CDS) notional according to a contract value of a basis point, a means for setting a standard recovery rate as a predetermined constant value, a means for determining a maximum running spread according to the standard recovery rate, implied CDS notional, and the contract value of the basis point, and a means for replacing any index component spread that exceeds the maximum running spread by the maximum running spread for determining the index value.

In another aspect of the invention, there can be a method of determining a maximum running spread of a unit with a plurality of components, including determining a first value according to a first component of the unit, determining a second value according to a contract value of a basis point, setting a standard recovery rate as a predetermined constant value, determining the maximum running spread according to the standard recovery rate, second value, first value, and the contract value of the basis point, and replacing any spread that exceeds the maximum running spread by the maximum running spread.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow chart illustrating a selection of index components according to a preferred embodiment of the invention.

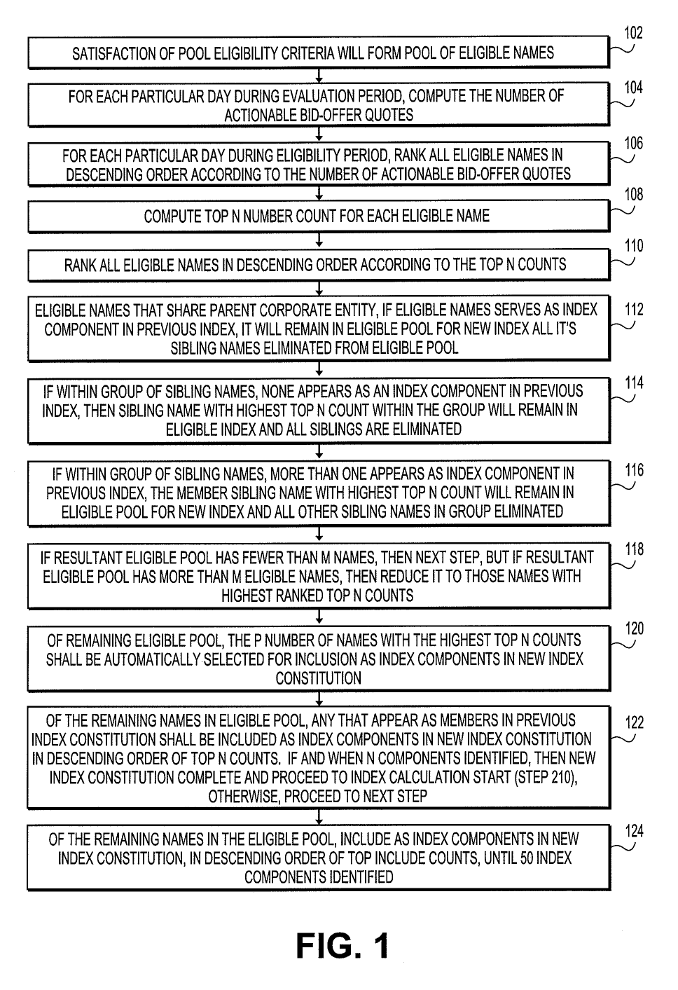

FIG. 2 is a flow chart of determining and applying the maximum running spread to index components according to a preferred embodiment of the invention.

FIG. 3 is a graphical illustration of the application of the maximum running spread.

FIG. 4 is another view of the graphical illustration of FIG. 3.

FIG. 5 illustrates an exemplary computer that can run the computer executable instructions of the present invention.

### DETAILED DESCRIPTION

The invention will now be described with reference to the drawing figures, in which like reference numerals refer to like parts throughout.

The Index components are based upon CDS spreads with the following characteristics shown as an example: taxable bond issues of corporations; priority of CDS reference securities such as senior, unsecured; maturity of CDS contracts: certain amount of years; type of restructuring of CDS contracts, such as modified restructuring; currency denomination of CDS contracts such as the Euro or United States dollar. These components are shown only as an example and are not limiting as other criteria could also be used.

Eligibility Criteria for Index Components can be as follows, but is not limited to such examples. There can be an eligibility evaluation period such as a certain period immediately preceding a roll date, where a roll date can be around certain periods of the year.

The actionable bid-offers on a predetermined period of time CDS spreads are delivered by dealers directly to their customers or to inter-dealer brokers during an eligibility evaluation period.

Credit ratings filters are reference securities that can be rated above a certain level such as BBB/Baa2 (ratings assigned by, for example, Moody's, Standard and Poors, Fitch, etc.) or higher by at least two primary recognized statistical rating organizations throughout the eligibility evaluation period.

The following procedure can govern the selection of Index Components for any reconstitution of the Index. Names that satisfy the eligibility criteria for index components, as mentioned above, will form the pool of eligible names (or “eligible pool”) (step 102). For example, if component A has a three month calendar period, it can satisfy the evaluation period criteria. Then if the component A has actionable bid offers on five-year CDS spreads delivered by dealers directly to their customers are within the data universe criteria. Further, if component A is rated at BBB/Baa2, then component A meets all of the example eligibility criteria and therefore, component A would be in the eligibility pool.

For each particular set of days or day, during the eligibility evaluation period for each eligible name, there is a computation of the number of actionable bid-offer quotes (step 104). The particular day can be, for example, each business day.

For each particular set of days or day during the eligibility evaluation period, there is a ranking all eligible names in descending order according to each name's number of actionable bid offer quotes, as determined in step 104 (step 106). Then, there can be a computation of the top N count for each eligible name, where N is an integer greater than zero. For example, N can be 50 so that the computation would be of the top 50 count for each eligible name (step 108). For any eligible name, the top-N count is defined as the number of days during the Eligibility Evaluation Period on which that name appears among the N highest-ranked eligible names, as determined in step 106.

Then there is a ranking of all eligible names in descending order according to their top-N counts, as determined in step 108 (step 110).

Thereafter, the eligible names that share a parent corporate entity (“sibling names”) are filtered from the ranking determined in step 110 as follows. If an eligible name serves as an Index Component in the previous Index constitution, it will remain in the eligible pool for the new Index constitution, and all of its other sibling names will be eliminated from the eligible pool (step 112).

If, within a group of sibling names, none appears as an Index Component in the previous Index constitution, then the sibling name with the highest top-N count within the group will remain in the eligible pool for the new Index constitution, and all of the other sibling names in the group will be eliminated from the eligible pool (step 114).

If, within a group of sibling names, more than one appears as an Index Component in the previous Index constitution, then the member sibling name with the highest top-N count within said group will remain in the eligible pool for the new Index constitution, and all of the other sibling names in the group will be eliminated from the eligible pool (step 116).

If the resultant eligible pool has fewer than M names, then one proceeds directly to the next step. If, however, the resultant eligible pool has M or more eligible names, then one reduces it to those M names with the highest-ranked top-N counts, as determined in steps 110 through 116 (step 118). M is any integer value above 0, but can be for example above N or 50 such as 60.

Of the remaining eligible pool, the P names with the highest top-N counts shall be automatically selected for inclusion as Index Components in the new Index constitution (step 120). P is an integer greater than zero, and can be less than N or 50, for example P can be 40 names.

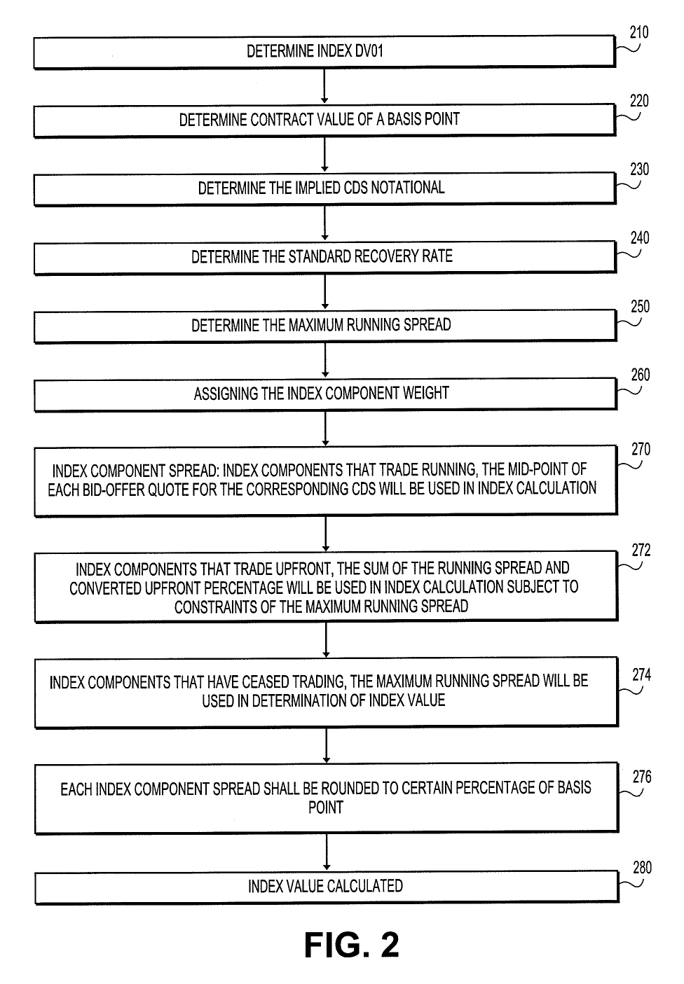

Of the remaining names in the eligible pool, any that appear as members in the previous Index constitution shall be included as Index Components in the new Index constitution in descending order of their top-N counts. If and when N Index Components have been identified, then the new Index constitution is complete, the technique proceeds to step 210, as seen in FIG. 2). If fewer than N Index Components have been identified, then the technique proceeds to the next step 124 (step 122).

Then in step 124, one must include the remaining names in the eligible pool as Index Components in the new Index constitution, in descending order of their top-N counts, until N Index Components have been identified (step 124), then proceed to step 210 of FIG. 2.

Referring to FIG. 2, the calculation of the index is shown in more detail. At the time a new Index is constituted, the following Index characteristics are disclosed. The steps shown below are shown as an example, and are not limited to the order or the number of steps. Certain steps can be deleted, and others can be added, and the order can be changed, or certain steps can be performed simultaneously.

First, there can be a determination of the Index DV01 in step 210. More specifically, the arithmetic average of DV01s of Index Components, based on $1 notional is the Index DV01. The Index DV01 will be computed using the following approximation for Index Component DV01s:

$$Index\_DV01 = \frac{1}{N} {\sum }_{i = 1}^{N} Index\_Component {\_DV01}_{i}$$

$$N = 50$$

$$Index\_Component {\_DV01}_{i} = \frac{1}{10 , 000} \frac{1 - exp ( - ( r + {λ}_{i} ) * T )}{r + {λ}_{i}}$$

T is the time period for the CDS, such as a 5 year CDS. Further r can equal the rate for the United States dollar 5 year swap. Then λᵢ is follows:

$${λ}_{i} = \frac{\begin{matrix}on the run 5 year CDS spread \\ for Index Component i\end{matrix} }{1 - Standard Recovery Rate}$$

The Index DV01 can be, for example, rounded to seven decimal places, with half increments in the eighth decimal place rounded up.

An example of the calculation of DV01 is to assume that the 5-year swap rate is 5 percent, that the on-the-run CDS spread for the i^{th} Index Component is 65 basis points, and that the Standard Recovery Rate has been set at 40 percent. Then: λi is equal to 0.0065/(1−0.4)=0.010833. Then the Index component DV01i would be as follows:

$$\begin{matrix}Index\_Component {\_DV01}_{i} = \frac{1}{10 , 000} \frac{1 - exp ( - ( 0.05 + 0.010833 ) * 5 )}{( 0.05 + 0.010833 )} \\ = 0.0004311\end{matrix}$$

Then in step 220, the contract value of a single basis point can be determined. The dollar value of a one basis point change in the Index Value. Please, note that this can be a defined term such as defined among the terms of the CBOT (Chicago Board of Trade) CDS Index futures contract, and thus can remain constant from one Index Construction date to the next.

For example the contract value of a basis point can be equal to the a tick value divided by the tick size, where the tick value can be 5 dollars and the tick size is 0.01 bp, thereby equaling $500/bp. The contract value of the basis point is, therefore, clearly not the Index DV01.

In step 230, the implied CDS Notional can be determined. The notional underlying value of, for example, a CBOT CDS Index futures contract implied jointly by the Index DV01 and the Contract Value of a Basis Point. For example, the Implied CDS Notional can be rounded to the nearest dollar, with half-dollars rounded up to the nearest dollar.

Implied CDS Notional=((Contract Value of a Basis Point)/Index DV01)×$1

As an example, if one were to assume again that the Index DV01 is $0.0004311/bp. Then, as mentioned above, by definition, the Contract Value of a Basis Point is $500/bp according to the constant stated by CBOT. Then the determination of the Implied CDS Notional would be as follows:

Implied CDS Notional=($500/bp)/($0.0004311/bp)×$1=$1,159,824

In step 240, the Standard Recovery Rate is determined. The standard recovery rate is defined as the recovery rate that will be used for DV01 calculations and for determining the Maximum Running Spread. The value of the Standard Recovery Rate can be set at the sole discretion of the Index manager at the time of each Index constitution. Additionally, the standard recovery can be a set depending on a set of predetermined circumstances. Further, the standard recovery can be a variable that changes according to a predetermined set of other variables.

For any given Index constitution, the value of the Standard Recovery Rate that the Index manager sets can remain fixed throughout the lifespan of that Index constitution and serve as the only value of the Standard Recovery Rate that the Index manager employs in maintaining that Index constitution.

The Index manager, at his/her sole discretion, may change the value of the Standard Recovery Rate from one Index reconstitution to the next, in accord with changes in prevailing market practice and/or market conditions.

In step 250, the Maximum Running Spread is determined. The Maximum Running Spread is basically a maximum value that the Index manager shall apply in calculating Index Component Spreads.

Stated another way, the maximum running spread is a cap on how high spreads can trade for a certain name if a credit event such as default is imminent. The Maximum Running Spread can be set as the following:

Maximum Running Spread=((1−Standard Recovery Rate)*Implied CDS Notional)/(Contract Value of a Basis Point)

Therefore, any Index Component Spread that exceeds the Maximum Running Spread shall be replaced by the Maximum Running Spread for the purpose of determining the Index Value. The Maximum Running Spread can be rounded to the nearest one one-hundredth ( 1/100) of one basis point, with half-hundredths rounded up to the nearest hundredth of one basis point.

As an example, assuming that the Standard Recovery Rate is 40 percent and that the Implied CDS Notional is $1,159,824. Then the Maximum Running Spread will be:

Maximum Running Spread=((1−0.4)*$1,159,824)/($500/bps)=1391.79 bps (basis point, or 1/100 of 1%)

In step 260, an index component weight can be determined, where initially, each Index Component will be assigned index weight of a predetermined amount, such as, one fiftieth ( 1/50), i.e., a 0.02 share of the Index composition.

Then, in steps 270-276, an index component spread is determined. An index component spread is for any Index Component, the Index Component Spread that the Index manager employs in computing the Index will depend upon whether CDS contracts that reference the corresponding Index Component name trade running or trade upfront.

An Index Component can identified at the sole discretion of the Index manager as to whether it is trading upfront or trading running, according to the conventions by which bid-offer prices are quoted for the corresponding CDS contracts. Therefore, the index component spread can be a constant number that is predefined.

First, step 270, shows the Index Components that are trade running. For any Index Component that trades running, the midpoint of each bid-offer quote for the corresponding CDS can be used in the Index calculation, subject to the constraint imposed by the Maximum Running Spread of step 250. A different point of each bid-offer can also be taken and thus the mid-point is not limiting.

In step 272, the Index components that trade upfront can be determined. For any Index Component that trades upfront, the sum of the running spread and the converted upfront percentage will be used in the Index calculation, subject to the constraint imposed by the Maximum Running Spread of step 250. The upfront percentage will be converted to an equivalent spread by multiplying the upfront percentage by the Implied CDS Notional and dividing by the Contract Value of a Basis Point.

As an example, one can assume again that the Implied CDS Notional is $1,159,824, and that one index component is trading at 18 percent upfront, 500 bps (basis point) running. Then, the corresponding Component Spread will be:

$$\begin{matrix}Component Spread = 500 bps + ( ( 0.18 * \$1 , 159 , 824 ) / \$500 / bps ) ) \\ = 917.54 bps\end{matrix}$$

Then in step 274, the Index components that have ceased trading are determined. For any Index Component that ceases to trade, for example, when actionable bid and offer prices cease to be quoted for the corresponding CDS contracts, the Maximum Running Spread will be used in determination of Index Value.

Then in step 276, Each Index Component Spread can be rounded to the nearest one one-hundredth ( 1/100) of one basis point, with half-hundredths rounded up to the nearest hundredth of one basis point. This approximation can set to another set of criteria.

Finally, in step 280, the Index Value Calculation is made. The Index Value is the sum of the products of each Index Component Weight and the corresponding Index Component Spread.

$$\begin{matrix}Index Value = {\sum }_{i = 1}^{Q} Index Component Weight \times \\ Index Component {Spread}_{i}\end{matrix}$$

Where Q is the number of components in the index. As stated in step 260, initially Q=50 and each Index Component Weight is 0.02. The Index Value, so computed, can be rounded to the nearest one one-hundredth ( 1/100) of one basis point, with half-hundredths rounded up to the nearest hundredth of one basis point.

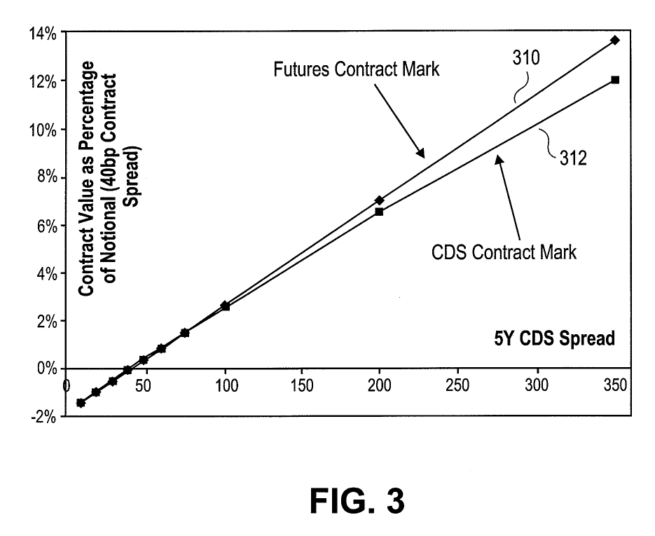

Relating back to step 250 of the maximum running spread of FIG. 2, the effect of using the maximum running spread is shown in FIG. 3. The contract value is graphed as a percentage of notional versus a five year CDS spread. The Futures contract is graphed as seen in reference 310 and the CDS contract is plotted as seen in reference 312. As seen in FIG. 3, the change in spread multiplied by a DV01 valuation instead of using a full CDS valuation model for a 40 bp contract is shown to works very well up to spread levels over 200 bps.

The convexity embedded within the CDS contract becomes apparent as the spreads widen past 350 bps. While it is not expected for the entire index to move from below 50 bps to over 200 bps over the course of three months, there is an expectation to see a single name widen to those levels due to idiosyncratic reasons. This first-order valuation method begins to break-down as spreads move higher than 500 bps. The contract fixes a 40% recovery rate and it is not expected that a single-name CDS contract to exceed 60% of notional. As spreads head to distressed levels, the contribution of a single name to futures contract value, in the absence of a spread cap, exceeds 100% of implied notional while an actual CDS contract approaches 60%.

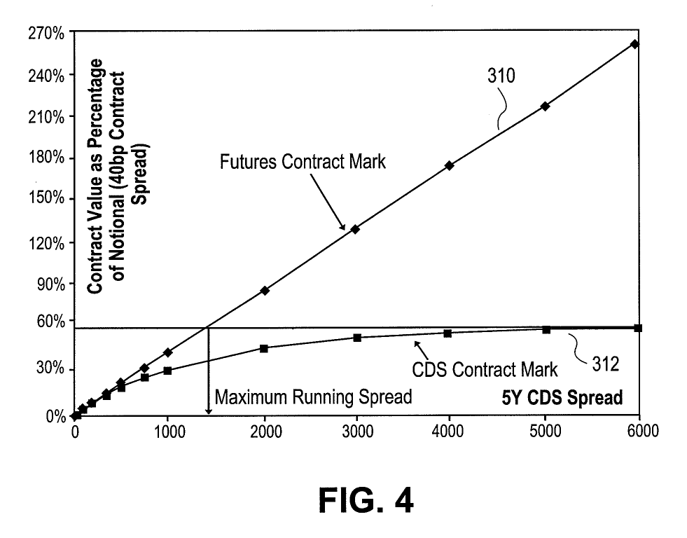

Referring to FIG. 4, for the reason shown above, the technique of the invention caps the dollar value of the contract at 60% of implied notional and then calculate the Maximum Running Spread by dividing this dollar amount by the dollar value of a contract basis point (for example, $500). This is equivalent to dividing 60% by the Index DV01 of a $1 contract. While this calculation is clear, it raises the question of how to calculate the Index DV01 and even why a single Index DV01 is used.

Therefore, alternatively, it is also possible to calculate individual Maximum Running Spreads and cap the index members' maximum spreads at different levels. Given how close the individual DV01's are to each other, we viewed this is generally not necessary, but can be performed. An additional point is that the DV01's are located in the denominator of a ratio used to calculate the Maximum Running Spread. Rather than averaging the DV01's and then dividing 60% of this value, it is efficient to calculate the individual Maximum Running Spreads and take the average. However, in application, this makes very little difference. For example, in the index roll for a certain period, it was noted that the average of the individual Maximum Running Spreads differed by only 0.13 bps from the Maximum Running Spread calculated using the average DV01.

The Maximum Running Spread can also be used in additional products such as either over the counter or on an exchange, whereby the payoff is not based on a credit event but rather based on a CDS level exceeding a specified threshold. The Maximum Running Spread can either being calculated at product inception using a formula similar to the shown above, or calculated dynamically or set to a predefined constant. The product is similar to a CDS with a buyer of protection paying premiums and a seller of protection obligated to make a payment in the event of the underlying CDS spread (or other measure of credit-worthiness) exceeding a certain threshold. This particular product can be called a Credit Threshold Swap (CTS). Further, use of the Maximum Running Spread is not limited to the CTS. Other securities, including futures and options, can be constructed to use the Maximum Running spread as a threshold to trigger and/or limit the payout of derivative securities. The Maximum Running Spread can also be used with regard to any type of trading method or market indicator. These are only examples as the Maximum Running Spread can be used beyond the financial industry and into other areas of application.

In general, the Maximum Running Spread (MRS) places a cap on individual constituent levels as shown above. Further, as shown above in the graphs of FIGS. 3 and 4, the MRS is based on correcting a linear approximation of a non-linear curve. Additionally, the MRS is determined by converting a maximum dollar value into CDS premium level. Moreover, if the market premia drops below the MRS, the MRS is ignored (which in the industry is called being not “sticky”).

The invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The invention can include the computer-readable medium having stored thereon a data structure including a plurality of fields containing data representing the techniques of the invention.

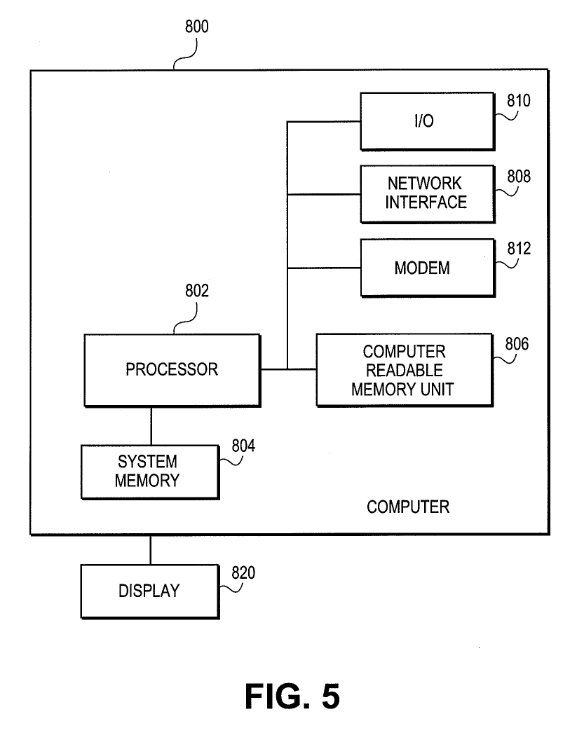

Referring to FIG. 5, an example of a computer, but not limited to this example of the computer 800, that can read computer readable media that includes computer-executable instructions of the invention. The computer 800 includes a processor 802 that uses the system memory 804 and a computer readable memory device 806 that includes certain computer readable recording media. A system bus connects the processor 802 to a network interface 808, modem 812 or other interface that accommodates a connection to another computer or network such as the Internet. The system bus may also include an input and output (I/O) interface 810 that accommodate connection to a variety of other devices. Furthermore, the computer 800 can output through, for example, the I/O 810, data for display on a display device 820.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of determining index component spreads, comprising:
determining an index DV01 according to index component DV01;
determining an implied credit default swap (CDS) notional according to a contract value of a basis point;
setting a standard recovery rate as a predetermined constant value;
determining a maximum running spread according to the standard recovery rate, implied CDS notional, and the contract value of the basis point; and
replacing any index component spread that exceeds the maximum running spread by the maximum running spread for determining the index value.

2. The method of claim 1, wherein the maximum running spread being determined by a product of the implied CDS notional with a value of one being subtracted by the standard recovery rate.

3. The method of claim 2, wherein the maximum running spread further comprises of dividing, the product of the implied CDS notional with the value of one subtracted by the standard recovery rate, with the contract value of the basis point.

4. The method of claim 1, wherein the standard recovery rate is a constant value according to certain preset conditions.

5. The method of claim 1, further comprising of assigning index components a certain predetermined weight.

6. The method of claim 1, further comprising of determining the index component spread according to whether they are trade running or trade upfront.

7. The method of claim 1, further comprising of using the maximum running spread in determination of the index value for the index components that have ceased trading.

8. The method of claim 1, determining the index according to the maximum running spread.

9. The method of claim 8, further comprising of determining a settlement value from the difference between the index value at a settlement date and the contract index value, and multiplying by the DV01.

10. The method of claim 1, wherein the implied notional of a contract being determined at the time the index is constructed based on the individual DV01's of the index members.

11. A set of computer executable instructions for determining index component spreads, stored in a computer readable media, comprising:
setting an index DV01;
determining an implied credit default swap (CDS) notional according to a contract value of a basis point and the DV01;
determining a maximum running spread according to the implied CDS notional, and the DV01; and
replacing any index component spread that exceeds the maximum running spread by the maximum running spread for determining the index value.

12. The method of claim 11, wherein the maximum running spread being determined by a product of the implied CDS notional with a value of one being subtracted by a predetermined constant value.

13. The method of claim 12, wherein the maximum running spread further comprises of dividing, the product of the implied CDS notional with the value of one subtracted by the predetermined constant value, with the contract value of the basis point.

14. The method of claim 11, wherein the predetermined constant value being set according to certain variables.

15. The method of claim 11, further comprising of assigning index components a certain predetermined weight.

16. The method of claim 11, further comprising of determining the index component spread according to whether they are trade running or trade upfront.

17. The method of claim 11, further comprising of using the maximum running spread in determination of the index value for the index components that have ceased trading.

18. The method of claim 11, determining the index according to the maximum running spread.

19. The method of claim 18, further comprising of determining a settlement value from the difference between the index value at a settlement date and the contract index value, and multiplying by the DV01.

20. The method of claim 11, wherein the implied notional of a contract being determined at the time the index is constructed based on the individual DV01's of the index members.

21. A system of determining index component spreads, comprising:
a means for determining a preset number of components in the index;
a means for setting an index DV01 for the components in the index;
a means for determining an implied credit default swap (CDS) notional according to a contract value of a basis point;
a means for setting a standard recovery rate as a predetermined constant value;
a means for determining a maximum running spread according to the standard recovery rate, implied CDS notional, and the contract value of the basis point; and
a means for replacing any index component spread that exceeds the maximum running spread by the maximum running spread for determining the index value.

22. The system of claim 21, wherein the means for determining the maximum running spread comprises by determining by a product of the implied CDS notional with a value of one being subtracted by the standard recovery rate.

23. The system of claim 21, wherein the means for determining the maximum running spread further comprises of dividing, the product of the implied CDS notional with the value of one subtracted by the standard recovery rate, with the contract value of the basis point.

24. The system of claim 21, wherein the means for determining the preset number of index components further comprises determining certain eligible names and ranking the eligible names.

25. The system of claim 21, wherein the preset number of index components using the maximum running spread in determination of the index value for the index components that have a credit event.

26. A method of determining a maximum running spread of a unit, comprising:
determining a first value according to a first component of the unit;
determining a second value according to a contract value of a basis point;
setting a standard recovery rate as a predetermined constant value;
determining the maximum running spread according to the standard recovery rate, second value, first value, and the contract value of the basis point; and
replacing any spread that exceeds the maximum running spread by the maximum running spread.

27. The method of claim 26, wherein the maximum running spread being determined by a product of the second value with a value of one being subtracted by the standard recovery rate.

28. The method of claim 26, wherein the maximum running spread further comprises of dividing, the second value with the value of one subtracted by the standard recovery rate, with the contract value of the basis point.

29. The method of claim 26, wherein the standard recovery rate is a constant value according to certain preset conditions.

30. The method of claim 26, further comprising of assigning the components of the unit a certain predetermined weight.
